(19) United States
(12) Patent Application Publication
(10) Pub. No.: US 2021/0182300 A1
(43) Pub. Date: Jun. 17, 2021

(54) BROKER CHAT BOT

(71) Applicant: ETORO GROUP LTD., Tortola (VG)

(72) Inventor: Johnathan Alexander ASSIA, Savyon (IL)

(21) Appl. No.: 17/128,717

(22) Filed: Dec. 21, 2020

Related U.S. Application Data
(62) Division of application No. 16/326,943, filed on Feb. 21, 2019.
(60) Provisional application No. 62/377,596, filed on Aug. 21, 2016.

(51) Int. Cl. G06F 16/2457; G06Q 30/02; G06F 16/00; G06Q 50/00; G06Q 40/04

(52) U.S. Cl. CPC G06F 16/24578; G06Q 30/0282; G06Q 40/04; G06Q 50/01; G06F 16/00

(57) ABSTRACT

A personalized recommendation system for providing personalized recommendations to a plurality of users, the personalized recommendation system comprising at least one processing resource configured to: obtain a list of Objects of Interest (OOIs) for each of the users, each OOI having one or more corresponding characteristics; calculate relevance scores for each of the OOIs, and for a plurality of other objects not included in the list, the relevance scores calculated utilizing at least one of the characteristics of the OOIs; provide, based on the relevance scores, one or more recommendations to each user, wherein each recommendation is for performing an action relating to a corresponding OOI from the list, or to a corresponding other object; and recalculate at least one of the relevance scores for each user, based at least on performance of the action by the respective user, or lack thereof.

### TECHNICAL FIELD

The invention relates to a broker chat bot, and more specifically to a system and method for automatically providing personalized recommendations to a plurality of users via broker chat bot software.

### BACKGROUND

In the past, trades in the financial markets were made by interacting with human brokers. Such brokers received instructions from their clients (also referred to herein as traders or investors interchangeably), optionally after providing the clients with recommendations (that were optionally personalized and based on their knowledge of the traders and their preferences). The commissions paid to the brokers were relatively high in order to justify such interactions between the clients and the brokers.

In more recent times, brokerage services are provided online, which enables reducing the commissions payable to the brokerage firms. However, the online brokers do not usually provide a personalized service, as the commissions charged do not justify such service. Therefore, only high-net worth investors receive personal brokerage services from human brokers.

In addition, human brokers have limited capacity on several fronts, including:
1. They are limited by the number of traders that they can serve;
2. They cannot interact with more than one trader simultaneously, which can result in lost opportunities for some of the traders that they serve;
3. Their capacity is limited to a relatively small number of assets that they can monitor;
4. They have a limited ability to keep up to date with the markets, and even with the limited number of assets that they can monitor.

There is thus a need in the art for a new method and system for automatically providing personalized recommendations to a plurality of users, for example using chat bot software.

References considered to be relevant as background to the presently disclosed subject matter are listed below. Acknowledgement of the references herein is not to be inferred as meaning that these are in any way relevant to the patentability of the presently disclosed subject matter.

US Patent Application No. 2007/083455 (Bove et al.), published on Apr. 12, 2007, discloses a computerized scheme automates investment planning for a client. In the scheme, data regarding the client's desired asset allocation, current asset portfolio and preferred domain are input into a processor. This data is used to automatically generate financial transaction recommendations for modifying the client's current asset portfolio to reach as close as possible to the desired asset allocation and the preferred domain. The recommendations include specific recommendations for selling amounts of selected current assets and specific recommendations for buying amounts of one or more investment funds.; The recommendations are displayed on a summary report for review by the client or the client's financial manager, or the recommendations are electronically communicated to a trade execution computer which automatically performs the necessary transactions to execute the buy/sell recommendations. The recommendations are selected in a manner which minimizes the tax impacts and transaction costs of potential sell transactions.

U.S. Pat. No. 6,349,290 (Horowitz et al.), published on Feb. 19, 2002, discloses an automated system and method for presenting both interactive and proactive customized and personalized advice for a customer by a financial institution is based on a sophisticated customer profile generated by the system according to an analysis of the customer from a totality of the customer's interaction with the system. The system includes, for example, an advice engine, which is primarily software, that considers numerous sets of system logic, such as legal constraints and statistical facts that affect the customer, and generates the advice. The system also includes a presentation engine which varies the presentation, depending in part on the mode by which the customer accesses the system, but regardless of the mode, presents the advice to the customer in an individualized manner. Additionally, the system includes a context assessment engine, which examines the context of the interaction between the customer and the system and assesses the effectiveness of the advice.

US Patent Application No. 2005/027632 (Zeitoun et al.), published on Feb. 3, 2005, discloses a computer-based system in which a user, e.g., a financial advisor, an investor, or a client of an investment firm, etc., may engage in an interactive dialog with a software-based investment advice system, hereafter referred to as the “Advisor” to receive analysis of present and potential financial investments. Based on information provided by the user, the Advisor may be configured to determine a recommended investment portfolio including investment allocations designed to meet at least one financial goal. A goal refers to a desired target accumulation of assets in connection with an investor's investment needs based on information a user has provided.

### General Description

In accordance with a first aspect of the presently disclosed subject matter, there is provided a personalized recommendation system for providing personalized recommendations to a plurality of users, the personalized recommendation system comprising at least one processing resource configured to:
(a) obtain a list of Objects of Interest (OOIs) for each of the users, each OOI having one or more corresponding characteristics;
(b) calculate relevance scores for each of the OOIs, and for a plurality of other objects not included in the list, the relevance scores calculated utilizing at least one of the characteristics of the OOIs;
(c) provide, based on the relevance scores, one or more recommendations to each user, wherein each recommendation is for performing an action relating to a corresponding OOI from the list, or to a corresponding other object; and
(d) recalculate at least one of the relevance scores for each user, based at least on performance of the action by the respective user, or lack thereof.

In some cases, the processing resource is further configured to insert at least one of the other objects to the list of a corresponding user if the corresponding user performed the action relating to the corresponding other object.

In some cases, the recommendations are provided for the OOIs, or the other objects, having a relevance score exceeding a threshold.

In some cases, the recommendations are provided ordered in accordance with one or more of the following: the calculated relevance scores of the corresponding OOIs, or the corresponding other objects, associated with the recommendations; an absolute periodical change of value of the corresponding OOIs, or the corresponding other objects, associated with the recommendations; a periodical change of value percentage of the corresponding OOIs, or the corresponding other objects, associated with the recommendations.

In some cases, the recommendations are provided at one or more pre-determined times.

In some cases, at least one of the recommendations is provided in real-time after calculation of the respective relevance score if the respective relevance score exceeds a pre-defined threshold.

In some cases, the processing resource is further configured to repeat steps (c) to (e) periodically.

In some cases, the items are tradable financial assets, and the characteristics include one or more of the following: a type of tradable financial asset; a sector with which the tradable financial asset is associated; and an exchange in which the tradable financial asset is traded.

In some cases, the recalculate is further based on one or more of the following additional parameters: information of one or more events relating to the tradable financial assets; a first effect of the events on first trades made by other users, other than the user for which the recalculation is performed, in the corresponding tradable financial assets to which the events relate; and a second effect of the events on second trades made by socially related other users, other than the user for which the recalculation is performed and for which the personalized recommendation system has an indication of the social relation of the socially related other users with the user for which the recalculation is performed, in the corresponding tradable financial assets to which the events relate, wherein the socially related other users are a subgroup of the other users.

In some cases, the events are one or more of: a change in the tradable financial asset price; a release of an earnings report of a company represented by the tradable financial asset; an announcement of the company represented by the tradable financial asset.

In accordance with a second aspect of the presently disclosed subject matter, there is provided a personalized recommendation method for providing personalized recommendations to a plurality of users, the personalized recommendation method comprising:
(a) obtaining, by a processing resource, a list of Objects of Interest (OOIs) for each of the users, each OOI having one or more corresponding characteristics;
(b) calculating, by the processing resource, relevance scores for each of the OOIs, and for a plurality of other objects not included in the list, the relevance scores calculated utilizing at least one of the characteristics of the OOIs;
(c) providing, by a processing resource, based on the relevance scores, one or more recommendations to each user, wherein each recommendation is for performing an action relating to a corresponding OOI from the list, or to a corresponding other object; and
(d) recalculating, by a processing resource, at least one of the relevance scores for each user, based at least on performance of the action by the respective user, or lack thereof.

In some cases, the method further comprises inserting, by the processing resource, at least one of the other objects to the list of a corresponding user if the corresponding user performed the action relating to the corresponding other object.

In some cases, the recommendations are provided for the OOIs, or the other objects, having a relevance score exceeding a threshold.

In some cases, the recommendations are provided ordered in accordance with one or more of the following: the calculated relevance scores of the corresponding OOIs, or the corresponding other objects, associated with the recommendations; an absolute periodical change of value of the corresponding OOIs, or the corresponding other objects, associated with the recommendations; a periodical change of value percentage of the corresponding OOIs, or the corresponding other objects, associated with the recommendations.

In some cases, the recommendations are provided at one or more pre-determined times.

In some cases, at least one of the recommendations is provided in real-time after calculation of the respective relevance score if the respective relevance score exceeds a pre-defined threshold.

In some cases, the method further comprises repeating steps (c) to (e) periodically.

In some cases, the items are tradable financial assets, and the characteristics include one or more of the following: a type of tradable financial asset; a sector with which the tradable financial asset is associated; and an exchange in which the tradable financial asset is traded.

In some cases, the recalculate is further based on one or more of the following additional parameters: information of one or more events relating to the tradable financial assets; a first effect of the events on first trades made by other users, other than the user for which the recalculation is performed, in the corresponding tradable financial assets to which the events relate; and a second effect of the events on second trades made by socially related other users, other than the user for which the recalculation is performed and for which the personalized recommendation system has an indication of the social relation of the socially related other users with the user for which the recalculation is performed, in the corresponding tradable financial assets to which the events relate, wherein the socially related other users are a subgroup of the other users.

In some cases, the events are one or more of: a change in the tradable financial asset price; a release of an earnings report of a company represented by the tradable financial asset; an announcement of the company represented by the tradable financial asset.

In accordance with a third aspect of the presently disclosed subject matter, there is provided a non-transitory computer readable storage medium having computer readable program code embodied therewith, the computer readable program code, executable by at least one processor of a computer to perform a method comprising:
a. obtaining, by a processing resource, a list of Objects of Interest (OOIs) for each of the users, each OOI having one or more corresponding characteristics;
b. calculating, by the processing resource, relevance scores for each of the OOIs, and for a plurality of other objects not included in the list, the relevance scores calculated utilizing at least one of the characteristics of the OOIs;
c. providing, by a processing resource, based on the relevance scores, one or more recommendations to each user, wherein each recommendation is for performing an action relating to a corresponding OOI from the list, or to a corresponding other object; and
d. recalculating, by a processing resource, at least one of the relevance scores for each user, based at least on performance of the action by the respective user, or lack thereof.

In accordance with a fourth aspect of the presently disclosed subject matter, there is provided a personalized recommendation system for providing personalized recommendations to a plurality of users, the personalized recommendation system comprising at least one processing resource configured to: obtain a plurality of lists of two or more items of interest, each list of the lists being associated with a corresponding user of the users, wherein a first list of the lists includes at least a first item of the items not included in at least a second list of the lists; calculate, for each list of the lists associated with each user of the users, a score for each item of the items of interest, the score being indicative of a level of interest of the user in the item, wherein the score is calculated based at least on a change of a value of at least one parameter (such as a quote of the item, etc.) associated with the item; and provide each user with a personalized recommendation to purchase a predetermined number of recommended item out of the items of interest having the highest scores.

In accordance with a fifth aspect of the presently disclosed subject matter, there is provided a personalized recommendation method for providing personalized recommendations to a plurality of users, the personalized recommendation method including: obtaining, by a processing unit, a plurality of lists of two or more items of interest, each list of the lists being associated with a corresponding user of the users, wherein a first list of the lists includes at least a first item of the items not included in at least a second list of the lists; calculating, by the processing unit, for each list of the lists associated with each user of the users, a score for each item of the items of interest, the score being indicative of a level of interest of the user in the item, wherein the score is calculated based at least on a change of a value of at least one parameter (such as a quote of the item, etc.) associated with the item; and providing, by the processing unit, each user with a personalized recommendation to purchase a predetermined number of recommended item out of the items of interest having the highest scores.

In accordance with a sixth aspect of the presently disclosed subject matter, there is provided a non-transitory computer readable storage medium having computer readable program code embodied therewith, the computer readable program code, executable by at least one processor of a computer to perform a method comprising: obtaining, by a processing unit, a plurality of lists of two or more items of interest, each list of the lists being associated with a corresponding user of the users, wherein a first list of the lists includes at least a first item of the items not included in at least a second list of the lists; calculating, by the processing unit, for each list of the lists associated with each user of the users, a score for each item of the items of interest, the score being indicative of a level of interest of the user in the item, wherein the score is calculated based at least on a change of a value of at least one parameter (such as a quote of the item, etc.) associated with the item; and providing, by the processing unit, each user with a personalized recommendation to purchase a predetermined number of recommended item out of the items of interest having the highest scores.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an environment of a system for providing personalized recommendations to a plurality of users via broker chat bot software, in accordance with the presently disclosed subject matter;

FIG. 2 is a block diagram schematically illustrating one example of a user device, in accordance with the presently disclosed subject matter;

FIG. 3 is a block diagram schematically illustrating one example of a recommendation server, in accordance with the presently disclosed subject matter;

FIG. 4 is a flowchart illustrating one example of a sequence of operations carried out by the recommendation server for providing personalized recommendations via broker chat bot software, in accordance with the presently disclosed subject matter;

FIG. 5 is a flowchart illustrating one example of a sequence of operations carried out by broker chat bot software installed on the user device for providing trading commands based on personalized recommendations, in accordance with the presently disclosed subject matter;

FIG. 6 is a flowchart illustrating another example of a sequence of operations carried out by the recommendation server for providing personalized recommendations via broker chat bot software, in accordance with the presently disclosed subject matter; and

FIGS. 7 and 8 are illustrations of scoring schemes, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “calculating”, “providing”, “receiving”, “performing”, “sending” or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

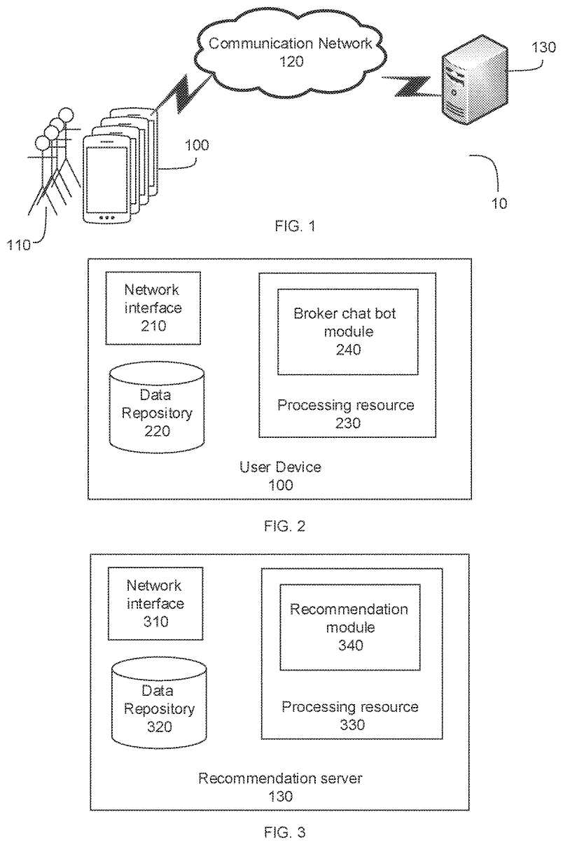

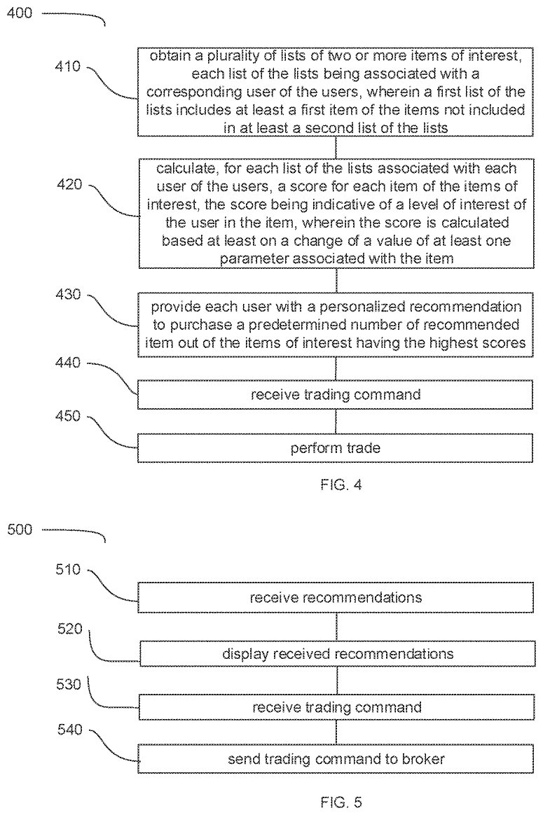

In embodiments of the presently disclosed subject matter, fewer, more and/or different stages than those shown in FIGS. 4-6 may be executed. FIGS. 1-3 illustrate a general schematic of the system architecture in accordance with an embodiment of the presently disclosed subject matter. Each module in FIGS. 1-3 can be made up of any combination of software, hardware and/or firmware that performs the functions as defined and explained herein. The modules in FIGS. 2-3 may be centralized in one location or dispersed over more than one location. In other embodiments of the presently disclosed subject matter, the system may comprise fewer, more, and/or different modules than those shown in FIGS. 2-3.

Bearing this in mind, attention is drawn to FIG. 1. FIG. 1 is a schematic illustration of an environment of a system for providing personalized recommendations to a plurality of users via broker chat bot software, in accordance with the presently disclosed subject matter.

According to certain examples of the presently disclosed subject matter, system environment 10 can comprise a recommendation server 130, and one or more user devices 100, each user device 100 associated with a corresponding user 110. The user devices 100 and the recommendation server 120 can be configured to communicate over a communication network 120 (e.g. any Internet Protocol (IP) based network, such as the Internet, an Intranet, or any other mechanism enabling the user devices 100 and the recommendation server 130 to communicate with one another).

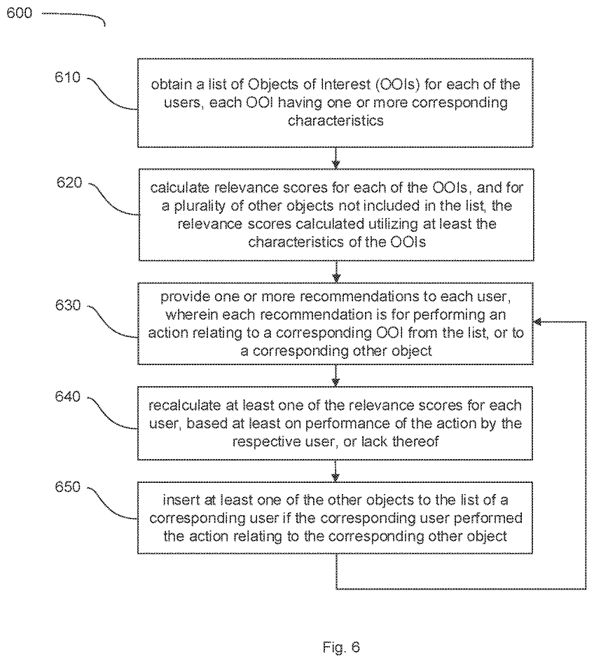

The recommendation server 130 can be configured to determine, for each user 110, one or more personal recommendations to trade one or more objects, also referred to herein as items, such as stocks, commodities, stock options, currencies, consumer products, etc., as further detailed herein, inter alia with reference to FIGS. 4 and 6. The personal recommendation/s can be provided to each user 110 by sending it, over the communication network 120, to the corresponding user device 100 of the user 110.

The user devices 100 can be configured to utilize a chat bot software (also referred to herein as “broker chat bot software” interchangeably) for displaying the personal recommendation/s, received from the recommendation server 130, to the designated users 110, and enable the users to send trading commands to the recommendation server 130 for making transactions relating to one or more of the recommended objects, as further detailed herein, inter alia with reference to FIG. 5. The chat bot software (also known as a “chatterbot” or “chatbot”, “chat robot”), can be configured to engage in a natural language dialogue with the user, utilizing Artificial Intelligence (AI) and Natural Language Processing (NLP), thereby enabling an interactive connection between the recommendation server 130 and the users 110 of the user devices 100.

It is to be noted that the chatbot can communicate with the users via textual interaction, utilizing a display of the user device 100 (where it can output text to the user and receive textual responses therefrom), and/or via voice interaction, utilizing a speaker and a microphone of the user device 100 (where it can interact with the user by outputting information by voice using the speaker and receive inputs from the user via the microphone). Whenever reference is made to the chatbot throughout the description, it is to be noted that its interaction with the user 110 can be made by voice and/or by text.

In some cases, the personal recommendation/s can be generated and provided to each user 110 on user-specific pre-determined times (e.g. every hour, every 12 hours, every 24 hours, every week, every month, etc., where each user can have different pre-determined times in which the recommendation/s can be provided thereto). In some cases, each user 110 can choose personalized times (e.g. a first user can choose to receive personalized recommendation/s every morning, or every morning between Monday-Friday, at 10:00, whereas a second user can choose to receive personalized recommendation/s every Sunday, at 20:00, etc.).

In some cases, the recommendation server 130 can automatically determine when to send personal recommendation/s to each user 110. In some cases, the determination can be based on machine learning, by analyzing past interactions of the users 110 with the recommendation server 130 and determining preferred times, preferred by each user 110, for interacting with the recommendation server 130. For example, the recommendation server 130 can determine that a first user of the users 110 prefers interactions to take place at 10:00, whereas a second user of the users 110 can prefer interactions to take place at 20:00, etc. The preferences of the users 110 can be determined by the recommendation system 130 sending the recommendations to each user of the users 110 at several times during the day over a certain learning time period (e.g. every hour during a period of one week), and check when each user actually interacted therewith. If the interactions took place during evening hours (e.g. 20:00), the recommendation server 130 can set future recommendations to be sent during the evening hours (e.g. 20:00). The recommendation server 130 can optionally be configured to reevaluate its findings periodically (e.g. every month), in order to identify changes in the users 110 interaction times preferences.

It is to be noted that the recommendation server 130 can provide at least one personalized recommendation every day to thousands of users 110, and in some cases to tens of thousands or hundreds of thousands or millions of users 110, or more.

Turning to FIG. 2, there is shown a block diagram schematically illustrating one example of a user device, in accordance with the presently disclosed subject matter.

According to certain examples of the presently disclosed subject matter, user device 100 includes a network interface 210, enabling connecting the user device 100 to communication network 120 and enabling it to send and receive data sent thereto through the communication network 120, including receiving personalized recommendation/s for presentation to a user 100 and sending trading command/s to the recommendation server 130, as detailed herein, inter alia with reference to FIG. 5.

The user device 100 can further comprise or be otherwise associated with a data repository 220 (e.g. a database, a storage system, a memory including Read Only Memory—ROM, Random Access Memory—RAM, or any other type of memory, etc.) configured to store data, including, inter alia, recommendations to be provided to the user 110, etc. In some cases, data repository 220 can be further configured to enable retrieval and/or update and/or deletion of the stored data. It is to be noted that in some cases, data repository 220 can be distributed.

The user device 100 further comprises a processing resource 230. Processing resource 230 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant user device 100 resources and for enabling operations related to user device 100 resources.

The processing resource 230 can comprise a broker chat bot module 240. According to some examples of the presently disclosed subject matter, the broker chat bot module 240 can be configured to receive one or more personalized recommendations, personalized for the user 110 associated with the user device 100, to trade one or more objects, also referred to herein as items, such as stocks, commodities, stock options, currencies, consumer products, etc.). In some cases, broker chat bot module 240 can be further configured to display the received personalized recommendations to the user 110 of the user device 100 using natural language (e.g. “hello John, I would like to recommend you buy APPL stocks today. Would you like to proceed?”, etc.) and enable the user to provide a trading command, using natural language (e.g. “Yes, please buy 1,000 APPL stocks”), and send the trading command to the recommendation server 130, as further detailed herein, inter alia with reference to FIG. 5. In some cases, the user can interact with the broker chat bot, for example for requesting more information (e.g. “what is the current price of an APPL stock?”, “Why do you recommend this?”, etc.).

In FIG. 3, there is shown a block diagram schematically illustrating one example of a recommendation server, in accordance with the presently disclosed subject matter.

According to certain examples of the presently disclosed subject matter, recommendation server 130 includes a network interface 310, enabling connecting the recommendation server 130 to communication network 120 and enabling it to send and receive data sent thereto through the communication network 120, including sending personalized recommendations for presentation to users 100 of user devices 110 and receiving trading commands from the user devices 110, as detailed herein, inter alia with reference to FIGS. 4 and 6.

The recommendation server 130 can further comprise or be otherwise associated with a data repository 320 (e.g. a database, a storage system, a memory including Read Only Memory—ROM, Random Access Memory—RAM, or any other type of memory, etc.) configured to store data, including, inter alia, market information relating to various objects (e.g. historical and/or real-time stock quotes, financial reports, news relating to stocks, etc.), information about the users 110 preferences (e.g. a list of objects, such as stocks, the user is interested at, etc.), information of trading activities of other users trading in the items, etc. as further detailed herein, inter alia with reference to FIGS. 4 and 6. In some cases, data repository 320 can be further configured to enable retrieval and/or update and/or deletion of the stored data. It is to be noted that in some cases, data repository 320 can be distributed.

The recommendation server 130 further comprises a processing resource 330. Processing resource 330 can be one or more processing units (e.g. central processing units), microprocessors, microcontrollers (e.g. microcontroller units (MCUs)) or any other computing devices or modules, including multiple and/or parallel and/or distributed processing units, which are adapted to independently or cooperatively process data for controlling relevant recommendation server 130 resources and for enabling operations related to recommendation server 130 resources.

The processing resource 330 can comprise a recommendation module 340. The recommendation module 340 can be configured to generate, for each user, one or more personalized recommendation to trade one or more items (e.g. stocks, commodities, stock options, currencies, consumer products, etc.), as further detailed herein, inter alia with reference to FIGS. 4 and 6.

Turning to FIG. 4, there is shown a flowchart illustrating one example of a sequence of operations carried out by the recommendation server for providing personalized recommendations via broker chat bot software, in accordance with the presently disclosed subject matter.

According to some examples of the presently disclosed subject matter, recommendation server 130 can be configure to perform a recommendation process 400, e.g. utilizing recommendation module 340.

For this purpose, recommendation server 130 can be configured to obtain a plurality of lists of two or more Objects of Interest (OOIs) (e.g. stocks, commodities, stock options, currencies, etc.), each list of the lists being associated with a corresponding user of the users 110, wherein a first list of the lists includes at least a first item of the items not included in at least a second list of the lists (block 410). In some cases, each user of the users 110 can provide the recommendation server 130 with indications of OOIs to be introduced into the list associated therewith and the lists can be generated by the recommendation server 130 accordingly (i.e. each list associated with each user will include the objects indicated by the respective user).

Additionally, or alternatively, the recommendation server 130 can automatically introduce objects into each list associated with each user. Objects can be introduced automatically into a list associated with a given user upon the recommendation server 130 identifying the given user trading the objects (e.g. if the given user traded a certain object such as an Apple stock, the object Apple stock can be introduced into the list) and/or identifying other on-line behavior of the given user (e.g. if the user entered a webpage associated with a certain object or posted a message relating to a certain object on an on-line social network—the object can be introduced into the list associated with the given item).

Additionally, or alternatively, the recommendation server 130 can be configured to introduce, into the list associated with a given user, objects that other users that meet certain criteria have traded during a pre-determined timeframe (e.g. in the past hour, in the past day, in the past week, etc.). The criteria can be used to identify users having preferences similar to the given user's preferences. The criteria can be, for example, that the other users lists comprise a certain number of objects (e.g. one, two, three, etc.) that are also in the list associated with the given user. For example, assuming that the given trader has five objects on his lists, out of which four objects also appear in the list of a second trader, and assuming that the second trader traded an object that is not in the list of the given trader—such object can be introduced into the list of the given trader.

It is to be noted that in some cases, the list can be updated periodically. In some cases, the list can be updated/regenerated at the beginning of the recommendation process 400.

The recommendation server 130 is further configured to calculate, for each list of the lists associated with each user of the users, a score for each object of the OOIs, the score being indicative of a level of interest of the user in the object, wherein the score is calculated based at least on a change of a value of at least one parameter associated with the object (e.g. a change in a quote of the object over a given timeframe, etc.) (block 420). For this purpose, the recommendation server 130 can be configured to monitor price quotes of the objects (e.g. stocks, etc.) and determine a change in the quote during a given predetermined timeframe (e.g. a given stock price increased by 10% during the last hour, etc.). For example, if a first stock quote changed by +10% over a timeframe of 30 minutes, and a second stock quote changed by +20% over a timeframe of 30 minutes, the ranking system can provide the second stock with a score higher than the score provided to the first stock.

In some cases, the score can additionally, or alternatively, be calculated based on analyst rankings available on-line (e.g. a ranking of a certain stock was raised by a certain analyst, e.g. from hold to buy, etc.), earning reports available on line (e.g. showing better than predicted revenues/profits, etc.) other news (e.g. a monitored website published an article containing an indication of initiation of a Merger and Acquisition (M&A) negotiations relating to a certain company whose stock is one of the items, etc.), etc.

In some cases, the scoring algorithm can also employ machine learning. For example, if a certain user responded to previous recommendations relating to specific objects better than to previous recommendations relating to other objects (e.g. trades relating to the specific objects following a recommendation relating thereto were made more often than trades relating to other objects following recommendations relating to the other objects), the scores calculated for such objects may be increased using various methods (e.g. by increasing the calculated grade by a certain percentage, e.g. ten percent, etc.).

It is to be noted that the amount of information that can be processed by the recommendation server 130 is incomparable to the capacity of a human broker. The recommendation server can monitor many thousands of stocks quotes and/or websites substantially simultaneously, which is impossible for any human broker.

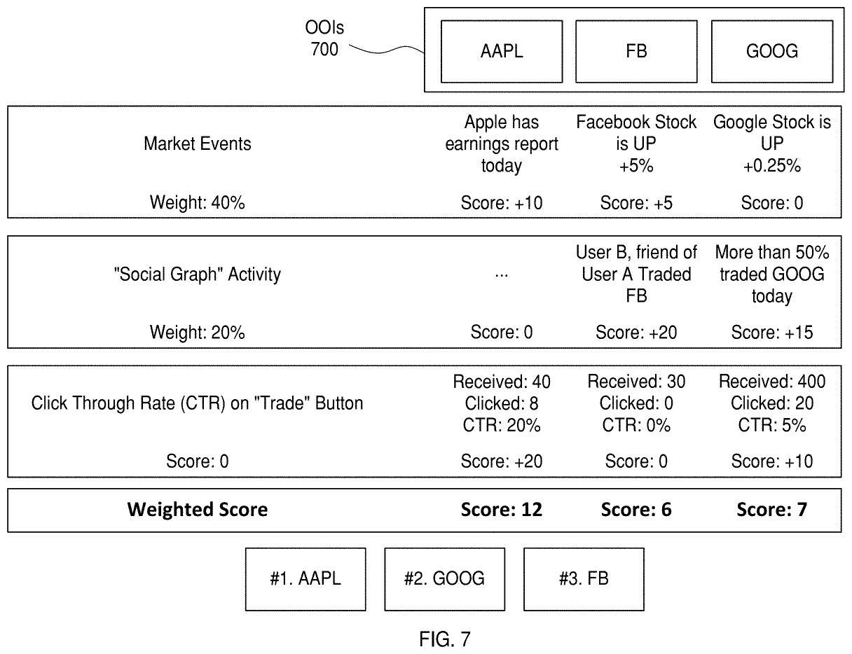

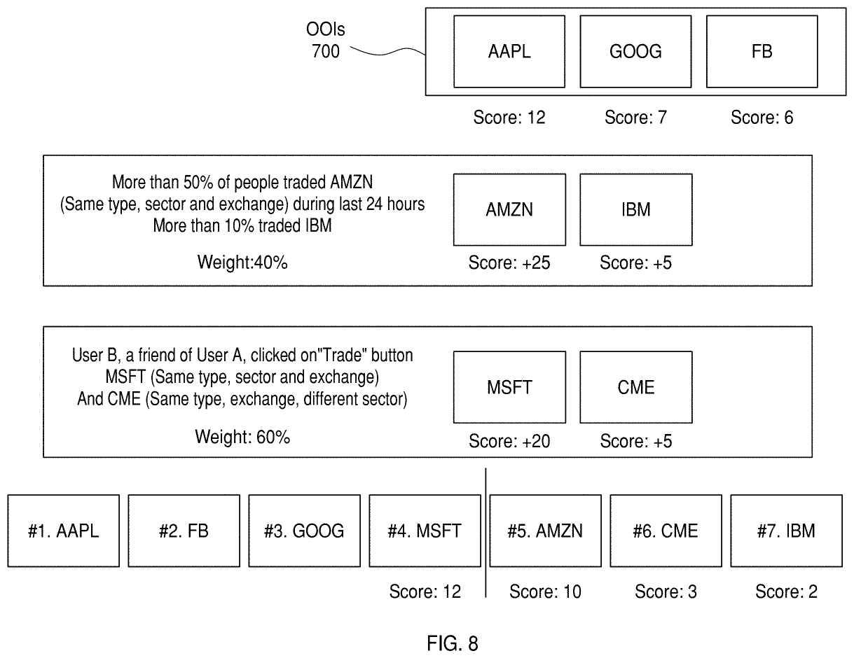

Before continuing with the description of FIG. 4, attention is drawn to FIGS. 6 and 7, showing an exemplary score calculation, in accordance with the presently disclosed subject matter.

In FIG. 6, a given user has selected three OOIs 700, namely: Apple Stock (APPL), Facebook stock (FB) and Google stock (GOOG), all three being stocks, in the Technology sector, being traded on NASDAQ exchange.

In accordance with the exemplary scoring algorithm, the recommendation server 130 monitors market events relating to the user's OOIs. In the illustrated example, the system has identified that Apple is due to release an earnings report at the same day (the day the score is calculated), which according to the exemplary scoring scheme results in a score increase of ten points in the Apple stock market events category. The recommendation server 130 further identifies that the Facebook stock is up by five percent (e.g. during a certain monitored time window), which according to the exemplary scoring scheme results in a score increase of five points in the Facebook stock market events category. The recommendation server 130 also identifies that the Google stock is up by a quarter percent (e.g. during a certain monitored time window), which according to the exemplary scoring scheme does not award it with any score increase in the Google stock market events category.

In addition, the recommendation server 130 monitors social activity relating to each of the OOIs. In the illustrated example, the recommendation server 130 has identified that a certain user that is socially associated with the user for which the scoring mechanism is activated, has traded the Facebook stock at the same day (the day the score is calculated), which according to the exemplary scoring scheme results in a score increase of twenty points in the Facebook stock social graph activity category. The recommendation server 130 also identifies that more than fifty percent of the users trading on the system have traded the Google stock at the same day (the day the score is calculated), which according to the exemplary scoring scheme results in a score increase of fifteen points in the Google stock social graph activity category. Furthermore, the recommendation server 130 did not identify any rule being met relating to the Apple stock, and therefore Apple is not awarded with any score increase in the social graph activity category.

The recommendation server 130 further monitors a Click Through Rate (CTR) of clicks on a trade button associated with the various stocks. In the illustrated example, the recommendation server 130 has identified that eight times, out of a total of forty times users have been provided with a recommendation to trade the Apple stock, the users actually clicked the trade button (a CTR of 20%), which according to the exemplary scoring scheme results in a score increase of twenty points in the Apple stock CTR category. The recommendation server 130 also identified that zero times, out of a total of thirty times users have been provided with a recommendation to trade the Facebook stock, the users actually clicked the trade button (a CTR of 0%), which according to the exemplary scoring scheme naturally does not results in a score increase in the Facebook stock CTR category. Furthermore, the recommendation server 130 has identified that twenty times, out of a total of four hundred times users have been provided with a recommendation to trade the Google stock, the users actually clicked the trade button (a CTR of 5%), which according to the exemplary scoring scheme results in a score increase of ten points in the Google stock CTR category.

In the illustrated example, a general weighted score is calculated based on the various category scores, where the market events category amounts to 40% of the general score, the social graph activity category amounts to 20% of the general score, and the CTR category amounts for the remaining 40% of the general score. Accordingly, the Apple stock score is: (10*0.4)+(0*0.2)+(20*0.4)=12, the Facebook stock score is: (5*0.4)+(20*0.2)+(0*0.4)=6, and the Google stock score is: (0*0.4)+(15*0.2)+(10*0.4)=7, resulting in the following descending order: Apple with twelve points, Google with seven points and Facebook with six points.

In FIG. 7, a score is calculated for objects that are not in the users OOI list. In the illustrated example, the recommendation server 130 identifies that more than fifty percent of the users trading on the system have traded the Amazon stock (being a stock of the same sector and exchange as the stocks in the user's OOIs list, namely Apple, Google and Facebook) at the same day (the day the score is calculated), which according to the exemplary scoring scheme results in a score increase of twenty-five points in the Amazon stock social graph activity category. Similarly, the recommendation server 130 identifies that more than ten percent of the users trading on the system have traded the IBM stock (also being a stock of the same sector and exchange as the stocks in the user's OOIs list, namely Apple, Google and Facebook) at the same day (the day the score is calculated), which according to the exemplary scoring scheme results in a score increase of five points in the Amazon stock social graph activity category.

In addition, the recommendation server 130 has identified that a certain user that is socially associated with the user for which the scoring mechanism is activated, has traded the Microsoft stock (being a stock of the same sector and exchange as the stocks in the user's OOIs list, namely Apple, Google and Facebook) at the same day (the day the score is calculated), which according to the exemplary scoring scheme results in a score increase of twenty points in the Microsoft stock social graph activity category. The same user that traded the Microsoft stock at the same day, also traded the CME Group stock (being a stock of the same exchange as the stocks in the user's OOIs list, namely Apple, Google and Facebook, but of a different sector than these stocks), which according to the exemplary scoring scheme results in a score increase of five points in the CME Group stock social graph activity category.

As indicated above, in the illustrated example, a general weighted score is calculated based on the various category scores, thereby resulting in the Amazon stock score being: (25*0.4)=10, the IBM score being: (5*0.4)=2, the Microsoft score being: (20*0.6)=12, and the CME group score being: (5*0.6)=3.

Therefore, assuming that the recommendation server 130 is configured to provide a recommendation relating to four objects, it will provide recommendations for the Apple, Facebook and Google stocks (that are all in the OOIs list of the user), and for the Microsoft stock, having a score of twelve, that is higher than the scores of Amazon, CME group and IBM.

Returning to FIG. 4, The recommendation server 130 is further configured to provide each user with a personalized recommendation to purchase a predetermined number of recommended objects out of the OOIs having the highest scores, utilizing the scores calculated for the list objects in block 420 (block 430). The personalized recommendation can be provided to each user 110 by sending it to its respective user device 100, where it can be processed and provided to the user via the chat bot mechanism. For example, the recommendation server 130 can provide each user with personalized recommendations to trade at least one object of the objects in the user's corresponding list, having the highest score. In some cases, the number of objects to be recommended can be determined by the respective user. As an example, a first user may request to receive a personalized recommendation to trade one object, whereas a second user may request to receive a personalized recommendation to trade five objects. In other cases, the number of objects to be recommended can be determined automatically, e.g. in accordance with certain criteria (e.g. any object whose score is higher than X is to be included in the recommendations, etc.).

In addition, the system can determine preferred interaction times to interact with the users (some users may respond better to recommendations sent in the morning hours, other users may respond better to recommendations sent in the evening). In some cases, the personal recommendations can be generated and provided to each user 110 on pre-determined times (e.g. every hour, every 12 hours, every 24 hours, every week, every month, etc.). In some cases, each user 110 can choose personalized times (e.g. a first user can choose to receive personalized recommendations every morning, or every morning between Monday-Friday, at 10:00, whereas a second user can choose to receive a personalized recommendation every Sunday, at 20:00, etc.).

In some cases, the recommendation server 130 can automatically determine when to send personal recommendations to each user 110. In some cases, the determination can be based on machine learning, by analyzing past interactions of the users 110 with the recommendation server 130 and determining preferred times, preferred by each user 110, for interacting with the recommendation server 130. For example, the recommendation server 130 can determine that a first user of the users 110 prefers interactions to take place at 10:00, whereas a second user of the users 110 can prefer interactions to take place at 20:00, etc. The preferences of the users 110 can be determined by the recommendation system 130 sending the recommendations to each user of the users 110 at several times during the day over a certain time period (e.g. every hour during a period of one week), and check when each user actually interacted therewith. If the interactions took place during evening hours (e.g. 20:00), the recommendation server 130 can set future recommendations to be sent during the evening hours (e.g. 20:00). The recommendation server 130 can optionally be configured to reevaluate its findings periodically (e.g. every month), in order to identify changes in the users 110 interaction times preferences.

It is to be noted that the recommendation server 130 can provide the personalized recommendations to many thousands of users substantially simultaneously, which is impossible for any human broker.

In some cases, the recommendation server 130 can be further configured to receive trading commands from the users 110 in response to the personalized recommendations (block 440), and to perform the trades defined in the trading commands (block 450), e.g. by opening a trade for a given stock being a given object according to the trading command. In some cases, the recommendations can be provided to the users 110 via the respective user devices 100 in an interactive manner (e.g. utilizing a messaging bot software), so that the users 110 can select to trade the objects that are recommended for them immediately upon the personalized recommendations are displayed on the user devices 100.

It is to be noted that in some cases the trades can be performed irrespective of an account balance of the user issuing the trading command, and a payment request can be sent to such user after the trade is performed. It is to be further noted that in some cases, prior to executing the trade, the recommendation server 130 can be configured to request authorization from the user instructing the trade, e.g. by sending the user 110, via the user device 100, an authorization request and awaiting receipt of authorization from the user 100 via the user device 100. In some cases, the authorization requires includes requesting the user 110 to record a confirmation in his voice and optionally confirming the user's identity using voice recognition techniques, and/or requesting a biometrical confirmation such as a fingerprint, etc.

It is to be noted that, with reference to FIG. 4, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

Attention is now drawn to FIG. 6, a flowchart illustrating another example of a sequence of operations carried out by the recommendation server for providing personalized recommendations via broker chat bot software, in accordance with the presently disclosed subject matter.

According to some examples of the presently disclosed subject matter, recommendation server 130 can be configure to perform a second recommendation process 600, e.g. utilizing recommendation module 340.

For this purpose, recommendation server 130 can be configured to obtain a plurality of lists of one or more Objects of Interest (OOIs) (e.g. stocks, commodities, stock options, currencies, etc.), each list being associated with a corresponding user of the users 110 (block 610). The OOIs in each list can be selected by the respective user 110 with which the list is associated. The OOIs can be selected by each user 110 from a list of objects presented thereto, or by the user 110 providing information enabling identification of the objects to be inserted into the list in any other manner. In some cases, the OOIs within each user's list are selected upon registration of the user 110, as part of a set-up of the user's 110 account.

Each object in the OOIs list includes at least one corresponding characteristic. In those cases where the objects are tradable financial assets the characteristics can be a type of object (e.g. a stock, a bond, a derivative, etc.), a sector with which the object is associated (e.g. technology sector, financial sector, energy sector, etc.), an exchange in which the object is traded (e.g. S&P500, NASDAQ, London Stock Exchange, etc.), and/or other/additional characteristics.

Recommendation server 130 then calculates, for each user 110, relevance scores for each of the OOIs, and for a plurality of other objects not included in the user's OOIs list (block 620). The relevance scores are calculated for each such object utilizing at least part of the characteristics of the OOIs within the user's list. The relevance scores can be calculated, for example, so that for any objects not included in the user's OOIs list, the score is increased for any shared characteristic between such object and the objects in the OOIs list. For example, assuming that the characteristics are object type, sector and exchange (e.g. a stock exchange in which the object is traded), objects that are of the same type, sector and are traded in the same exchange will have a higher score than objects from a different type/sector/exchange. In some cases, the objects in the OOIs list will have a pre-determined relevance score higher than the relevance score of each object not in the OOIs list, thereby reflecting the fact that the objects in the OOIs list are selected by the user 110 as being of interest.

In a given example of calculating the relevance scores of objects not in the OOIs list, a first number of points can be added to a relevance score of each object for each OOI in the user's OOI list of the same type, a second number of points (that can be identical to the first number or different therefrom) can be added to a relevance score of each object for each OOI in the user's OOI list of the same sector, and a third number of points (that can be identical to the first and/or second number or different therefrom) can be added to a relevance score of each object for each OOI in the user's OOI list traded in the same exchange as the object. It is to be noted that this is a mere example and other relevance score calculation methods can be used.

In some cases, the relevance scores can be calculated additionally, or alternatively, based on market events relating to corresponding objects (whether they are in the 00Is list, or not). A market event can be a change of a value of at least one parameter associated with the object (e.g. a change in a quote of the object over a given timeframe, etc.). For this purpose, the recommendation server 130 can be configured to monitor price quotes of the objects (e.g. stocks, etc.) and determine a change in the quote during a given predetermined timeframe (e.g. a given stock price increased by 10% during the last hour, etc.). For example, if a first stock quote changed by +10% over a timeframe of 30 minutes, and a second stock quote changed by +20% over a timeframe of 30 minutes, the ranking system can add to the relevance score of the second stock a higher number of points than the number of points added to the relevance score of the first stock. The number of points added to the relevance score can be higher the higher the change in the quote is during a certain time period.

A market event can additionally or alternatively be publication of new analyst rankings available on-line (e.g. a ranking of a certain stock was raised by a certain analyst, e.g. from hold to buy, etc.), publication of new earning reports available on line (e.g. showing better than predicted revenues/profits, etc.), publication of a report of planned distribution of dividends, publication of other news (e.g. a monitored website published an article containing an indication of initiation of a Merger and Acquisition (M&A) negotiations relating to a certain company whose stock is one of the items, etc.), etc. In such cases, where a certain publication relating to an object is published, the relevance score of the respective object can be increased by a certain number of points.

In some cases, the relevance score can be calculated additionally, or alternatively, based on an effect of a market event on other users, other than the user 110, trading in the corresponding object. An effect can be, for example, an increase/decrease in the number of traders trading the object during a given time frame (e.g. a day), compared to a certain corresponding (e.g. daily) average during a given period (e.g. the last day, the last week, the last month, etc.), so that the larger the change is with respect to the average during the given period—the higher the number of points added to the relevance score is. For example, if during the last week, the average daily number of trades in a given object was ten, the number of points added to the relevance score of the object will increase the farther the number of daily trades in the objects is from the average daily number, so that if the object was traded twenty times during the past day, a first number of points will be added to its relevance score, and if the object was traded fifty times during the past day, a second number of points, higher than the first number of points, will be added to its relevance score.

In some cases, the relevance score can be calculated additionally, or alternatively, based on an effect of a market event on users that are socially related to the user 110 for which the relevance score of the object is calculated. For this purpose, the recommendation system can maintain information of social relationships between the various users thereof. In some cases, the socially related users are a subgroup of the other users using the recommendation system. An effect, as indicated above, can be, for example, an increase/decrease in the number of traders trading the object during a given time frame (e.g. a day), compared to a certain corresponding (e.g. daily) average during a given period (e.g. the last day, the last week, the last month, etc.), so that the larger the change is with respect to the average during the given period—the higher the number of points added to the relevance score is. It is to be noted that in some cases, the weight given to trades made by socially related traders is higher than the weight given to the other traders.

Based in the calculated relevance scores, the recommendation server 130 can be configured to provide one or more recommendations to each user 110, wherein each recommendation is for performing an action relating to a corresponding OOI from the list, or to a corresponding other object (block 630). The recommendation can be a recommendation to buy/sell a given/selected quantity of the corresponding object. In some cases, a recommendation can be provided with respect to each object having a calculated relevance score exceeding a certain threshold. The recommendation can be provided to each user 110 by sending it to its respective user device 100, where it can be processed and provided to the user 110, e.g. via the chat bot mechanism. In those cases where more than one recommendation is provided to a given user, the recommendations can be provided ordered according to one or more of: the calculated relevance scores of the corresponding OOIs, or the corresponding other objects, associated with the recommendations; an absolute periodical change of value of the corresponding OOIs, or the corresponding other objects, associated with the recommendations; a periodical change of value percentage of the corresponding OOIs, or the corresponding other objects, associated with the recommendations.

The recommendations can be provided at one or more pre-determined times. Additionally, or alternatively, one or more of the recommendations can be provided in real-time, e.g. after calculation of the respective relevance score, if the respective relevance score exceeds a pre-defined threshold. In additional, or alternative, cases, the recommendation server 130 can automatically determine when to send personal recommendations to each user 110. In some cases, the determination can be based on machine learning, by analyzing past interactions of the users 110 with the recommendation server 130 and determining preferred times, preferred by each user 110, for interacting with the recommendation server 130. For example, the recommendation server 130 can determine that a first user of the users 110 prefers interactions to take place at 10:00, whereas a second user of the users 110 can prefer interactions to take place at 20:00, etc. The preferences of the users 110 can be determined by the recommendation system 130 sending the recommendations to each user of the users 110 at several times during the day over a certain time period (e.g. every hour during a period of one week), and check when each user actually interacted therewith. If the interactions took place during evening hours (e.g. 20:00), the recommendation server 130 can set future recommendations to be sent during the evening hours (e.g. 20:00). The recommendation server 130 can optionally be configured to reevaluate its findings periodically (e.g. every month), in order to identify changes in the users 110 interaction times preferences.

It is to be noted that the recommendation server 130 can provide the personalized recommendations to many thousands of users substantially simultaneously, which is impossible for any human broker.

It is to be noted that in some cases an object not in the OOIs list can be recommended before any object from the OOIs list is recommended (if at all), for example if it has a higher relevance score than objects in the OOIs list, which can happen, for example, when market events relating to this object occur that result in it having a higher relevance score than the relevance score of the objects within the OOIs list.

In some cases, the recommendation server 130 can be further configured to recalculate at least one of the relevance scores for each user 110, based at least on performance of the action by the respective user 110, or lack thereof (block 640). In those cases where a recommendation relating to a certain object was provided to a given user 110 (whether the object is within the OOIs list of the user 110 or not), its relevance score can be decreased in those cases where the recommendation did not trigger any action (e.g. buy/sell) relating to such object. In those cases where the recommendation did not trigger any action (e.g. buy/sell) relating to such object, the relevance score of such object can be decreased, by a subtracting a certain number of points (that can be predetermined, or calculated, e.g. as a certain percent of the current relevance score etc.) therefrom. It is to be noted that in some cases, the recalculation can also include all, or part, of the additional/alternative calculations detailed with respect to block 620.

In some cases, the recommendation server 130 is further configured to insert at least one of the other objects to the OOIs list of a corresponding user 110 if the corresponding user 110 performed the action according to the recommendation relating to the corresponding other object (block 650). For example, if the recommendation server 130 provided a given user 110 with a recommendation relating to a given object not included in the user's OOIs list, and the user 110 acted upon such recommendation, the given object can be inserted into the OOIs list of such user 110.

In some cases, the recommendation server 130 can be further configured to repeat blocks 630 to 650, e.g. periodically, while noting that block 650 is optional.

It is to be noted that, with reference to FIG. 6, some of the blocks can be integrated into a consolidated block or can be broken down to a few blocks and/or other blocks may be added. It is to be further noted that some of the blocks are optional (e.g. block 650). It should be also noted that whilst the flow diagram is described also with reference to the system elements that realizes them, this is by no means binding, and the blocks can be performed by elements other than those described herein.

Turning to FIG. 5, there is shown a flowchart illustrating one example of a sequence of operations carried out by broker chat bot software installed on the user device for providing trading commands based on personalized recommendations, in accordance with the presently disclosed subject matter.

According to some examples of the presently disclosed subject matter, user device 100 can be configure to perform a recommendation interaction process 500, e.g. utilizing broker chat bot module 240.

For this purpose, user device 100 can be configured to receive the personalized recommendations sent thereto in block 430 or in block 630 (block 510), and display the received personalized recommendations, e.g. on a display of the user device 100, in a natural language using chat bot software (e.g. “Hi John, would you like to sell MSFT stocks today?”) (block 520).

The user device 100 can be further configured to receive trading command from its respective user 110, that can also be provided in natural language and analyzed for extracting trading commands from the natural language by Artificial Intelligence of the chat bot software (e.g. “Yes please, let's sell all of my MSFT holdings” (block 530) and send the received trading commands to the recommendation server for execution (block 540). The chat bot software is an interactive software enabling the user 110 to provide a command to trade the recommended items immediately upon the personalized recommendations are displayed on the user devices 100. In some cases, the user can interact with the broker chat bot software, for example for requesting more information (e.g. “what is the current price of an MSFT stock?”, “Can you provide another recommendation?”, etc.), and the broker chat bot can be configured to obtain the required information for responding to the user.

It is to be noted that, with reference to FIG. 5, some of the blocks can be integrated into a consolidated block or can be broken down to a few blocks and/or other blocks may be added. It is to be further noted that some of the blocks are optional. It should be also noted that whilst the flow diagram is described also with reference to the system elements that realizes them, this is by no means binding, and the blocks can be performed by elements other than those described herein.

It is to be noted that although the foregoing description refers, in some cases, to a recommendation system for tradable financial assets, this is by no means limiting, and other uses can be found for the system and method disclosed herein, including, for example, recommendations relating to music or movies (the user can select certain songs/artists/movies/song categories/movie categories and get recommendations of content based on relevance scores that can be calculated also based on a trend score, sharing, views by other users, and/or other socially-related users, etc.), travel (the user can select destinations as objects of interest and get flights and/or hotel deals based on relevance scores that can be calculated also based on price drops, clicks, purchases made by other users, and/or other socially-related users, etc.), eCommerce (the user can select certain items or item categories available for purchase on-line and get recommendations to purchase items based on relevance scores that can be calculated also based on price drops, popularity and ratings, clicks, purchases, etc.), news (the user can select certain news sections or news categories available on-line and get recommendations of news content based on relevance scores that can be calculated also based on readability, engagement, sharing, etc.), medicine, and many other fields in which it is desirable to provide personalized recommendations.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A user device comprising one or more processing units, the one or more processing units comprising a chat bot module configured to:
a) receive, from a recommendation server, one or more recommended trades of financial assets for a user,
the recommended trades being calculated, by the recommendation server, in accordance with, at least, whether a trade was executed responsive to one or more recommended trades previously output to the user;
b) output, to the user, the one or more recommended trades; and
c) responsive to a receiving, from the user, a trading command based on the one or more recommended trades,
transmit the trading command to the recommendation server for execution;
thereby facilitating an interactive handshake between the recommendation server and the chat bot user device.

2. A recommendation server, comprising one or more processing units, the one or more processing units configured to:
repeatedly:
a) calculate, for a user, one or more recommended trades of financial assets,
the calculating being in accordance with, at least, whether the recommendation server received a trading command responsive to one or more recommended trades previously output to the user; and
b) transmit, to the user device of the user, one or more calculated recommended trades,
the user device being configured to output the one or more recommended trades to the user;
thereby facilitating an interactive handshake between the recommendation server and the chat bot user device.

3. The system of claim 1, wherein the outputting utilizes a natural language interface.

4. The system of claim 1, wherein the outputting comprises displaying on a screen.

5. The system of claim 1, wherein the outputting comprises playing on a speaker.

6. The system of claim 1, wherein the receiving a trading command comprises receiving input from the user via a microphone.

7. The system of claim 2, wherein a time of transmitting is in accordance with, at least, previous interactions of the user device of the user with the recommendation server.

8. The system of claim 2, wherein the one or more processors are further configured to:
c) responsive to a receiving, from the user device, a trading command based on the one or more recommended trades,
perform one or more trades defined in the command;

9. A personalized recommendation system comprising:
a recommendation server, operably connectable to a communications network and comprising one or more processing units, the one or more processing units configured to:
repeatedly:
a) calculate, for a user, one or more recommended trades of financial assets,
the calculating being in accordance with, at least, whether a trade was executed responsive to one or more recommended trades previously output to the user, and
b) to the user device of the user, one or more calculated recommended trades,
the user device being configured to output the one or more recommended trades to the user,
thereby facilitating an interactive handshake between the recommendation server and the chat bot user device; and
one or more user devices, each user device operably connectable to a communications network and comprising one or more processing units comprising a chat bot module, each chat bot module configured to:
a) receive, from the recommendation server, one or more recommended trades of financial assets for a user,
the recommended trades being calculated, by the recommendation server, in accordance with, at least, whether a trade was executed responsive to one or more recommended trades previously output to the user;
b) output, to the user, the one or more recommended trades; and
c) responsive to a receiving, from the user, a trading command based on the one or more recommended trades,
transmit the trading command to the recommendation server for execution;
thereby facilitating an interactive handshake between the recommendation server and the chat bot user device.
